(19) United States
(12) Patent Application Publication
(10) Pub. No.: US 2025/0261183 A1
(43) Pub. Date: Aug. 14, 2025

(54) Multipath TCP Over Multi-Hop Heterogeneous Wireless IoT Networks

(71) Applicants: Mitsubishi Electric Research Laboratories, Inc., Cambridge, MA (US); Mitsubishi Electric Corporation, Tokyo (JP)

(72) Inventors: Jianlin Guo, Newton, MA (US); Kieran Parsons, Gloucester, MA (US); Yukimasa Nagai, Tokyo (JP); Takenori Sumi, Tokyo (JP); Naotaka Sakaguchi, Tokyo (JP); Hikaru Tsuchida, Tokyo (JP); Pu Wang, Cambridge, MA (US); Philip Orlik, Cambridge, MA (US)

(73) Assignees: Mitsubishi Electric Research Laboratories, Inc., Cambridge, MA (US); Mitsubishi Electric Corporation, Tokyo (JP)

(21) Appl. No.: 18/439,847

(22) Filed: Feb. 13, 2024

(51) Int. Cl. H04W 72/12; H04L 45/24; H04L 69/14; H04L 69/163; H04W 80/06

(52) U.S. Cl. CPC H04W 72/12; H04L 45/24; H04L 69/14; H04L 69/163; H04W 80/06

(57) ABSTRACT

A node device for forming a multi-hop network is provided. The node device is configured to support one communication interface or two communication interfaces, a low speed communication interface and a high speed communication interface. The node device participates in a heterogeneous multi-hop wireless network to simultaneously deliver data packets over multipath TCP (MPTCP) paths. A MPTCP path establishment method is provided for node device to build multiple paths to a data center. An adaptive congestion control algorithm is developed for node device to control congestion on a MPTCP path based on path properties such as path length, path bandwidth and path loss. A Markov chain model is provided for IEEE 802.15.4 Non-Slotted CSMA algorithm to compute round trip time on a MPTCP path, wherein a M/M/1/K model is applied to compute the queuing time. Based on round trip time computed and adaptive congestion control window computed, a novel path scheduling method is provided for node device to deliver data to data center. The node device includes a transceiver configured to receive and transmit regular data and other packets in a heterogeneous wireless network, a memory configured to store computer executable programs including paths of node device, round trip times for the paths and path information for downstream nodes, and a processor configured to perform steps of the computer executable programs. The steps include building paths and controlling congestion and computing round trip time and scheduling packet transmission.

### FIELD OF THE INVENTION

This invention relates generally to transport data in wireless communications networks, and particularly to reliably transport data over multiple paths in heterogeneous wireless communications networks.

### BACKGROUND OF THE INVENTION

With the advent of 5G and beyond communication technologies, the consumer IoT devices are evolving from current generation to next generation. Next generation IoT devices can multiple communication interfaces, which are referred as to multi-link devices, and perform more functions. Accordingly, IoT network technologies must adapt to the emerging multi-link devices to improve network performance.

It is impractical to completely remove the deployed current generation devices during the evolution phase. As a result, the next generation IoT networks will consist of the mixed current generation and next generation devices.

Take next generation smart meter network for example, current generation meters support one communication interface and collect regular metering data only, on the other hand, next generation meters can support multiple communication interfaces such as IEEE 802.15.4, IEEE 802.11 and 5G, collect regular metering data and sense power supply information. The power supply information is critical for smart grid to make predictive maintenance and diagnose the cause of the abnormal events such as power outage and therefore and therefore, must be reliably delivered. To this end, power supply information can be delivered using Multipath TCP (MPTCP) protocol over multiple paths to ensure the reliability.

MPTCP protocol is a transport layer protocol desired for networks with multi-link devices. MPTCP protocol standardized in IETF standard RFC 8684 is an evolution of conventional TCP protocol to allow the simultaneous use of multiple interfaces for reliable data delivery. MPTCP protocol aims to improve throughput, improve reliability and reduce latency via the simultaneous use of multiple data delivery paths built by using multiple communication interfaces.

Despite the success of the MPTCP in computer networks, its deployment over wireless networks is not well studied, especially over carrier sense multiple access (CSMA) based wireless networks, in which random backoff delay incurs great challenges for path scheduling. In wireless IoT networks such as smart meter networks, there is no dedicated router. Data nodes need to deliver their own data and relay data for other nodes if necessary. As a result, the network environment is different from that in router based networks.

Accordingly, it is desirable to provide multipath TCP technologies to reliably deliver high priority data in heterogeneous wireless IoT networks.

### SUMMARY OF THE INVENTION

Some embodiments of the invention are based on recognition that the consumer IoT devices are evolving from the current generation to the next generation, wherein the current generation devices support single communication interface and perform one simple function, wherein the next generation devices can support multiple communication interfaces and perform more functions, wherein the devices supporting multiple communication interfaces are referred as to multi-link devices.

Some embodiments of the invention are based on recognition that next generation IoT devices can sense data that are critical to maintain normal operation of the IoT networks. These high priority data must be reliably delivered to data centers to be analyzed by network manager.

Some embodiments of the invention are based on recognition that it is impractical to completely remove the deployed current generation devices. As a result, next generation IoT networks will consist of the mixed current generation nodes and multi-link nodes that support multiple communication interfaces, wherein the IEEE 802.15.4 and 5G communication standards are used as example wireless communication technologies to illustrate the invented Multipath TCP methods over the heterogeneous wireless IoT networks.

To that end, one object of various embodiments of the invention is to form the heterogeneous wireless IoT networks using data centers, the mixed IEEE 802.15.4 data nodes and multi-link data nodes that support both IEEE 802.15.4 and 5G communication interfaces, wherein the data centers are considered as multi-link nodes, wherein an IEEE 802.15.4 node can communicate with data centers, neighboring IEEE 802.15.4 nodes and multi-link nodes via low speed IEEE 802.15.4 interface, wherein a multi-link node can communicate with neighboring

IEEE 802.15.4 nodes via low speed IEEE 802.15.4 interface and with data centers and 5G base stations (BSs) via high speed 5G interface.

Some embodiments of the invention are based on recognition that a multi-link node can either communicate with a data center directly or connects to a data center via base station network, where the operation of base station network is managed by network infrastructure. Accordingly, the base station network can be conceptually viewed as one base station node.

Some embodiments of the invention are based on recognition that the first task to setup MPTCP transport over communications networks is to build MPTCP paths, wherein a multi-link node builds a 1-hop path to data center if it can directly communicate with a data center or builds a 2-hop path to data center if it connects to data center via base station network, wherein an IEEE 802.15.4 node builds a 1-hop path to data center if it can directly communicate with a data center or build multiple multi-hop paths if it cannot directly communicate with any data center.

Some embodiments of the invention are based on recognition that the nodes in a wireless network form a mech topology in which a node can have physical connectivity with many neighboring nodes. Therefore, a node may build many paths to a data center. It is impractical to build a large number of paths.

Accordingly, various embodiments of the invention define a number of path threshold NPₜ to limit the number of paths to be built.

Some embodiments of the invention are based on recognition that once paths are established, the MPTCP scheduler can schedule data transmissions from data nodes to data centers, wherein MPTCP path scheduling depends on the RTT, congestion control parameters and path properties such as bandwidth, path loss and buffer size.

Accordingly, various embodiments of the invention provide a RTT computation method over heterogeneous paths consisting of IEEE 802.15.4 nodes and/or multi-link nodes, wherein the time a packet (data-packet) consumed at an IEEE 802.15.4 node includes (1) random queuing time, (2) random channel access time, (3) fixed RX to TX turnaround time, (4) fixed packet transmission time (once packet size and bandwidth is given) and (5) fixed MAC layer ACK packet transmission time (since IEEE 802.15.4 MAC sends a MAC ACK before forwarding packet to upper layers), wherein the time a TCP packet spent at a multi-link node consists of random queuing time and fixed packet transmission time only. Accordingly, main tasks are to compute random queuing time for both IEEE 802.15.4 node and multi-link node and random channel access time for IEEE 802.15.4 node.

Some embodiments of the invention are based on recognition that it is impractical to compute exact values of random variables. To that end, some embodiments of the invention provide methods to compute the expected queuing time and the expected channel access time, wherein a Markov chain model is provided to compute the expected IEEE 802.15.4 backoff time needed to transmit a packet, wherein another Markov chain model is provided to illustrate adaptive congestion control mechanism.

Some embodiments of the invention are based on recognition that MPTCP path scheduling must ensure the packets transmitted over multiple paths arrive at destination in order.

It is one object of some embodiments to provide a path scheduling method that considers the RTT and packet loss to deliver data packets over multiple MPTCP paths and ensure the packets arrive at a data center in order.

Some embodiments of the invention are based on recognition that the congestion control parameters are used by path scheduling to compute the number of packets can be scheduled on a path.

Accordingly, some embodiments of the invention provide an adaptive congestion control method to configure congestion control parameters based on wireless network conditions.

Additionally, the present invention provides a method to compute the expected time needed to deliver multiple packets from a data node to a data center.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A shows conventional TCP protocol stack;

FIG. 1B depicts MPTCP protocol stack;

FIG. 2 is a schematic illustrating a heterogeneous wireless IoT network consisting of a data center, IEEE 802.15.4 data nodes, multi-link data nodes supporting both IEEE 802.15.4 and 5G interfaces and the 5G base stations, according to some embodiments of the present invention;

FIG. 3 shows an example of multipath TCP (MPTCP) paths established for data nodes in a heterogeneous wireless IoT network, according to some embodiments of the present invention;

FIG. 4 shows the MPTCP NewReno congestion control algorithm;

FIG. 5 depicts the IEEE 802.15.4 Non-Slotted Carrier Sense Multiple Access with Collision Avoidance (CSMA-CA) algorithm;

FIG. 6 demonstrates the maximum possible unit backoff periods can be consumed in an IEEE 802.15.4 Non-Slotted CSMA-CA channel access attempt, according to some embodiments of the present invention;

FIG. 7 is a schematic illustrating the provided Markov Chain Model for IEEE 802.15.4 Non-Slotted CSMA-CA algorithm, according to some embodiments of the present invention;

FIG. 8 illustrates round trip time (RTT) computation over a multi-hop MPTCP path in wireless IoT networks by using TCP synchronization (SYN) and acknowledgement (ACK), according to some embodiments of the present invention;

FIG. 9 shows hop-to-hop RTT computation over a multi-hop MPTCP path in wireless IoT networks, according to some embodiments of the present invention; and

FIG. 10 illustrates MPTCP path scheduling mechanism from a data node D to a data center C on NPₜ paths, according to some embodiments of the present invention.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION OF THE PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

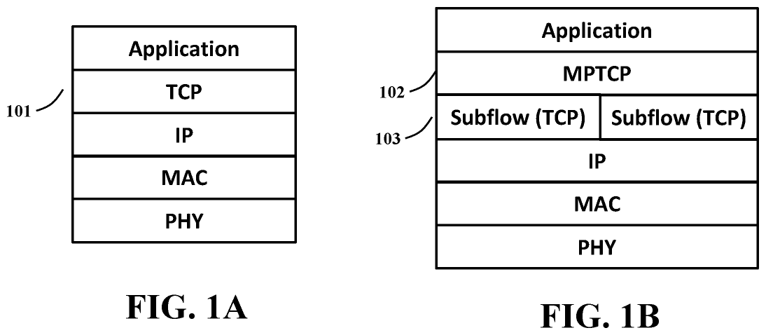

Some embodiments of the present invention are based on recognition as follows. MPTCP is a set of additional features on top of conventional TCP to enable a transport connection to operate across multiple paths simultaneously. FIG. 1A shows the conventional TCP protocol stack, where TCP layer 101 is in between application layer and IP layer. FIG. 1B shows the MPTCP protocol stack, where MPTCP layer 102 is in between application layer and TCP layer 103, where a MPTCP flow can be distributed to multiple TCP subflows. MPTCP is transparent to both higher and lower layers. To application layer, a MPTCP connection appears like a conventional TCP connection. To IP layer, each MPTCP subflow looks like a conventional TCP flow. MPTCH has achieved success in computer networks such as Ethernet networks. The studies have shown that simultaneously using multiple interfaces can achieve higher throughput and complete transmissions in a shorter time.

The main components of MPTCP protocol include (1) path management, (2) path scheduling and (3) congestion control.

(1): Path management in computer networks (infrastructure network) is performed by infrastructure network, i.e., router network. The Linux Kernel implements four path managers: (a) default, (b) fullmesh, (c) ndiffPorts and (d) binder. In default mode, the path management mechanism doesn't create new subflows. Therefore, only one communication interface is used even if there are multiple communication interfaces. In fullmesh mode, multihomed hosts advertise addresses to peers and create a complete mesh of new subflows across all possible pairs of IP addresses. In ndiffPorts mode, path manager initiates subflows between the same IP pair using different source and destination ports. It can hence create any number of subflows between a pair of IP addresses. In binder mode, path manager uses loose source and record routing (LSRR) without modification of the end-user devices. Binder provides a list of available gateways to MPTCP subflows and ensures that subflows visit these gateways and explore all available paths in the network. The packets of subflows are distributed over the network using relays and proxies to explore available network paths. Recently, MPTCP path management methods for wireless networks have been proposed, e.g., MPTCP path management for 5G and WiFi networks and cross-layer MPTCP path management approach for vehicular networks. However, there is no prior art report that addresses how to build MPTCP paths, which is the first step needed to setup MPTCP transport. Therefore, MPTCP path establishment methods are needed, especially for MPTCP over wireless networks.

(2): Path scheduling is the most studied MPTCP component. The round trip time (RTT) is one of required parameters by MPTCP path scheduler and is defined by IETF standard RFC 793 as the elapsed time between sending a data octet and receiving an acknowledgment. The Fastest-RTT is a default scheduler, in which the paths are scheduled based on RTT with the smaller RTT paths having higher priorities. Round robin and redundant are also two typical schedulers. Using round robin, paths are scheduled in a round robin fashion. With redundant, data are redundantly sent on all available paths. There are scheduling methods that enhances the Fastest-RTT scheduler by considering other metrics, e.g., delay-aware scheduling, blocking estimation-based scheduling and loss-aware scheduling. However, no prior art found addresses RTT computation, which is critical for MPTCP path scheduling and challenging to compute in wireless networks. Accordingly, new path scheduling methods are needed, especially for MPTCP over wireless IoT networks.

(3) The congestion control is critical for MPTCP to achieve high network efficiency, especially in data-centric networks. Although there are alternative congestion control methods, the NewReno algorithm specified in IETF standard RFC 6582 is a default congestion controller for MPTCP. However, the NewReno algorithm is designed for computer networks (infrastructure networks) with dedicated routers, where network condition is relatively stable. On the other hand, wireless IoT networks typically have no dedicated router and network condition is dynamic. To that end, the congestion control methods for wireless networks are needed.

In the following, IEEE 802.15.4 and 5G communication standards are used as example wireless communication technologies to illustrate the invented Multipath TCP techniques over the heterogeneous wireless IoT networks. In addition, the device-to-device (D2D) communication in 5G is not fully supported yet, to that end, the communication between multi-link nodes is not considered. As a result, a multi-link node can communicate with IEEE 802.15.4 node using low speed IEEE 802.15.4 interface and communicate with data center or 5G base station using high speed 5G interface.

With the advent of 5G and beyond communication technologies, the consumer IoT devices are evolving from current generation to next generation. Next generation IoT devices can multiple communication interfaces, which are referred as to multi-link devices, and perform more functions. Accordingly, IoT network technologies must adapt to the emerging multi-link devices to improve network performance.

It is impractical to completely remove the deployed current generation devices during the evolution phase. As a result, the next generation IoT networks will consist of the mixed current generation and next generation devices.

Take smart meter network for example, current generation meters support one communication interface and collect regular metering data only, on the other hand, next generation meters can support multiple communication interfaces such as IEEE 802.15.4, IEEE 802.11 and 5G, collect regular metering data and sense power supply information. The power supply information is critical for smart grid to make predictive maintenance and diagnose the cause of the abnormal events such as power outage and therefore and therefore, must be reliably delivered.

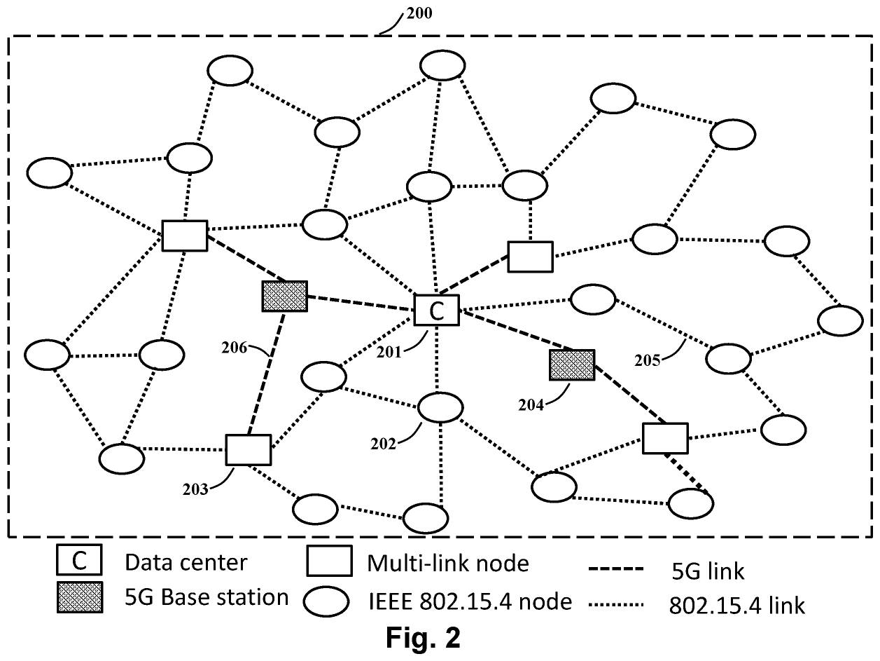

FIG. 2 illustrates a heterogeneous wireless IoT network 200 consisting of a data center 201, IEEE 802.15.4 data nodes 202, multi-link data nodes 203 and 5G base stations 204, wherein the multi-link nodes support both IEEE 802.15.4 and 5G communication interfaces. The data center is considered as a multi-link node. The nodes form a multi-hop mesh network based on physical connectivity, where the general flow of data packets is from the data nodes (802.15.4 nodes or multi-link nodes) to data center 201, although control messages such as acknowledgment (ACK) messages can be sent in either direction. At least one data node cannot directly communicate with data center 201, in other words, at least one data node in the heterogeneous wireless communications network is unsupported from direct communication with the data center. Therefore, the communication needs to be relayed by intermediate nodes. An 802.15.4 node can only communicate using low rate 802.15.4 communication interface. However, a multi-link node can communicate using both low rate 802.15.4 communication interface and high rate 5G communication interface. As a result, a low rate link 205 is formed by two 802.15.4 nodes or by an 802.15.4 node and a multi-link node. On the other hand, a high rate link 206 can only be formed by a multi-link node and a 5G base station or a multi-link node and a data center.

To deliver high priority data in IoT networks such as power supply information in smart meter network, the multipath TCP (MPTCP) protocol can be applied to ensure the reliability. MPTCP protocol is a transport layer protocol desired for networks with multi-link devices. MPTCP protocol standardized in IETF standard RFC 8684 is an evolution of conventional TCP protocol to allow the simultaneous use of multiple interfaces for reliable data delivery.

### MPTCP Path Establishment Over Heterogeneous Wireless IoT Networks

In wired networks, paths are built via physical wires even more logical paths can be established. In CSMA based wireless networks, nodes form a mesh topology based on physical communication links. A node may have connectivity with many nodes in the network and thus, can establish a large number of paths to a destination. However, it is impractical to build too many paths. Accordingly, a number of path threshold NP, is defined to limit the number of paths to be established.

No prior art found addresses how MPTCP paths are built. The present invention provides a path establishment method for heterogeneous wireless IoT networks consisting of IEEE 802.15.4 nodes and multi-link nodes that support both IEEE 802.15.4 and 5G communication interfaces. For multi-link nodes, paths in 5G network are managed by base station network, which can be conceptually viewed as a super 5G node. Consider that the device-to-device (D2D) communication in 5G is not fully supported yet. Therefore, the communication between multi-link nodes is not considered. As a result, a multi-link node builds a 1-hop path to data center if it directly connects to data center or builds a 2-hop path if it connects to data center via base station network. For IEEE 802.15.4 nodes, a multi-path routing protocol can be applied to build MPTCP paths. IETF IPv6 Routing Protocol for Low-Power and Lossy Networks (RPL) is a multi-path routing protocol, which is applied to illustrate MPTCP path establishment. The RPL organizes nodes in a network as a Destination Oriented Directed Acyclic Graph (DODAG) using the DODAG Information Object (DIO) message to establish upward routes and using the Destination Advertisement Object (DAO) message to setup downward routes. The present invention extends DIO message to contain path traversed and node type (NT), 0 for IEEE 802.15.4 node and 1 for multi-link node, and extends DAO message to contain path built and path ID. The extended fields in DIO message are used by downstream nodes to build MPTCP paths. The extended fields in DAO message are used by upstream nodes to store MPTCP paths for downstream nodes as {Source Node ID, Path ID, Upward Next Hop, Downward Next Hop}.

Data center C starts path establishment by broadcasting DIO message via both 5G and IEEE 802.15.4 interfaces with traversed path={C} and NT=1. Upon receiving a DIO message over 5G network, a 5G base station rebroadcasts the received DIO message to multi-link nodes that connect to the base station. Upon receiving a DIO message over 5G network, a multi-link node builds a 1-hop pat ={Node, C} if the transmitter of DIO message is node C or builds a 2-hop path={Node, BS, C} if the transmitter of DIO message is a base station. The multi-link node then updates DIO message with the path built and NT=1, broadcasts the updated DIO message in IEEE 802.15.4 network using IEEE 802.15.4 communication interface to propagate path establishment, assigns a path ID to the path and sends a DAO message to node C alone the path. Upon receiving the DIO messages, an IEEE 802.15.4 node selects parents using RPL protocol criteria such as the rank and builds paths={Node, Path contained in the received DIO message}. If the number of paths exceeds NP1, the node can replace an existing path with a better path by considering path length, the number of multi-link nodes on the path and buffer size of the next hop node on the path. A shorter path is considered as a better path than a long path. For equal length paths, a path with more multi-link nodes is considered better than a path with less multi-link node. If path length and the number of multi-link nodes are same, a path with next hop node having larger buffer is considered better than a path with next hop having smaller buffer. For each path built, an 802.15.4 node broadcasts an updated DIO message with the path built and NT=0 to propagate path establishment. The node then assigns a path ID to the path and sends a DAO message for upstream nodes to store its path. Upon receiving a DAO message, a node records a path for the DAO source node as {Source Node ID, Path ID, Upward Next Hop, Downward Next Hop}. The stored path record is used to forward the upward data packet and downward ACK packet. In addition, an IEEE 802.15.4 node can build a path through IEEE 802.15.4 node only or through mixed IEEE 802.15.4 node and multi-link node.

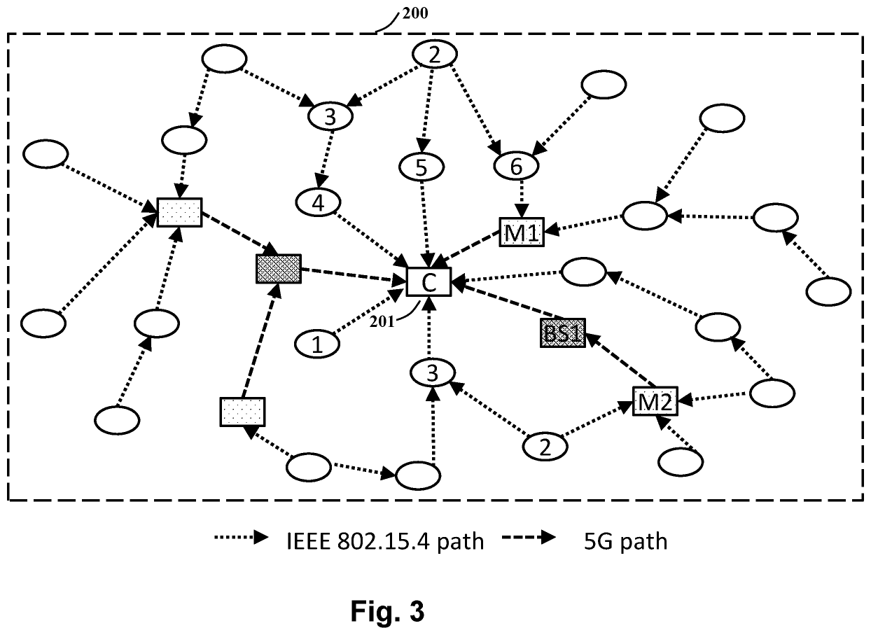

FIG. 3 shows an example of multipath establishment for the network illustrated in FIG. 1, where IEEE 802.15.4 node 1 builds a 1-hop path 1→C and IEEE 802.15.4 node 2 build three paths, a 3-hop path 2→3→4→C, a 2-hop path 2→5→C and another 3-hop path 2→6→M1→C, where path 2→3→C is an IEEE 802.15.4 node only path and path 2→6→M1→C is a mixed node path. Also, in FIG. 3, multi-link node M1 builds a 1-hop path M1→C and multi-link node M2 build a 2-hop path M2→BS1→C.

### Adaptive NewReno Algorithm for Wireless IoT Networks

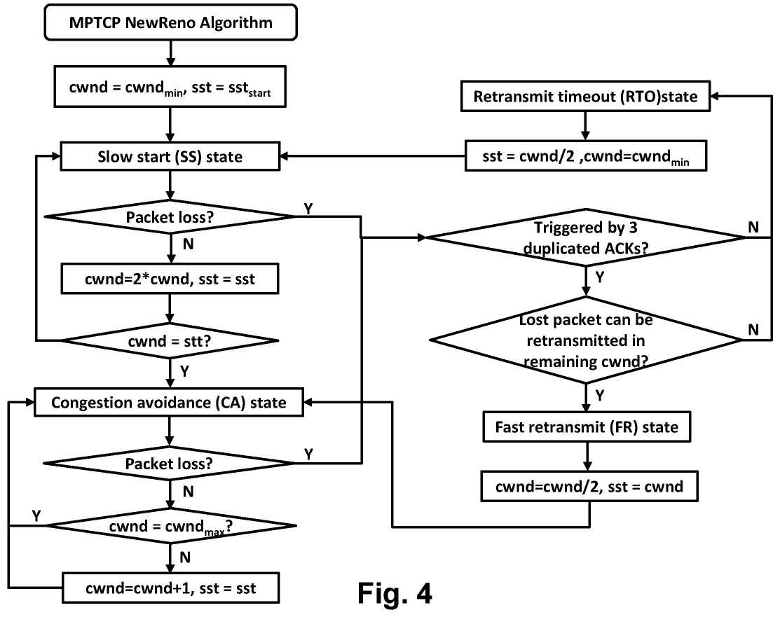

MPTCP NewReno algorithm uses congestion window (cwnd), slow start threshold (sst) and receiver window (rwnd) to control congestion. The cwnd limits the number of packets can be transmitted in a scheduling round and the rwnd indicates amount of data receiver willing to accept. A general rule to configure the cwnd is that the number of inflight packets plus cwnd is less or equal to rwnd. FIG. 4 illustrates the NewReno algorithm, which starts in slow start (SS) state with cwnd=cwndₘᵢₙ and sstₛₜₐᵣₜ set to the largest advertised rwnd or a value based on network path. If there is no packet loss in a scheduling round, the cwnd is doubled in next scheduling round. When the cwnd reaches sst, the algorithm transits to congestion avoidance (CA) state, in which the cwnd increments by 1 in each scheduling round until the cwnd reaches cwndₘₐₓ. In either SS state or CA state, if packet loss occurs in a scheduling round, the algorithm transits to fast retransmit (FR) state if the loss is triggered by three duplicate ACKs and the lost packet can be recovered within the remaining cwnd or otherwise to retransmit timeout (RTO) state. If the algorithm goes to FR state, both sst and dwnd are set to cwnd/2. If algorithm goes to RTO state, sst is set to cwnd/2 and cwnd is then set to cwndₘᵢₙ. The NewReno algorithm was designed for computer networks with dedicated routers, where network condition is relatively stable, therefore does not fit wireless network well.

Wireless network condition is dynamic. Wireless IoT networks typically have no dedicated routers. For multi-hop data-centric IoT networks, the bottlenecks are the nodes close to data center. Therefore, the NewReno algorithm needs to be enhanced accordingly. An adaptive NewReno (A-NewReno) algorithm is provided for MPTCP to be applied over multi-hop heterogeneous wireless IoT networks. A-NewReno algorithm provides following enhancements:
(1) The cwndₘᵢₙ and cwndₘₐₓ adaptation: in which cwndₘᵢₙ and cwndₘₐₓ are not uniform across network. Data nodes close to data center have smaller cwndₘᵢₙ and larger cwndₘₐₓ. As data nodes get away from data center, cwndₘᵢₙ becomes larger and cwndₘₐₓ becomes smaller as long as cwndₘᵢₙ≤cwndₘₐₓ. This enhancement considers factor that it is time consuming for data nodes away from data center to recover packet loss due to multi-hop relay and therefore, a relatively stable cwnd is needed. On the other hand, data nodes close to data center can quickly respond to packet loss.
(2) RTO timer adaptation: Setting RTO timer is challenging. IETF RFC 793 provides a method to set RTO=min{UB, max{LB,(β*SRTT)}}, where UB is an upper bound, LB is a lower bound, β is a delay variance factor and smoothed RTT (SRTT) is given by SRTT=α*SRTT+(1−α)*RTT, where a is a smoothing factor. An adaptive RTO timer configuration is provided, in which RTO timer is set to be proportional to path length with longer paths having longer RTO timer and shorter paths having shorter RTO timer. This adaptation is based on the fact that the longer paths typically take more time to deliver data. On the other hand, shorter paths take less time to deliver data.
(3) The cwnd update frequency adaptation: It is not necessary for data nodes away from data center to update the cwnd in each scheduling round. These nodes can explore the cwnd values that provide good performance and then maintain the cwnd until the cwnd leads to poor performance.

### Modeling IEEE 802.15.4 Non-Slotted CSMA Algorithm

IEEE 802.15.4 random backoff delay in channel access contention can be significant. Accordingly, to compute the RTT over a path consisting of IEEE 802.15.4 node, the random backoff delay must be considered. IEEE 802.15.4 specifies two CSMA operation modes: Slotted and Non-Slotted. IoT networks typically adopt IEEE 802.15.4 Non-Slotted mode. Therefore, the present invention models IEEE 802.15.4 Non-Slotted CSMA algorithm as a Markov chain model to compute the expected number of backoff periods needed to transmit a data packet.

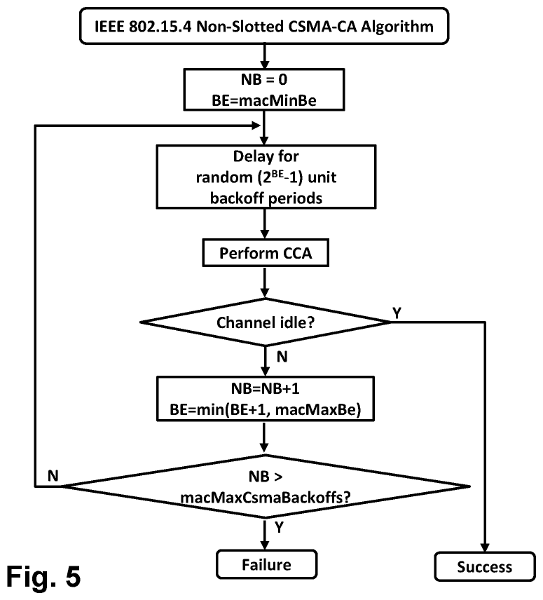

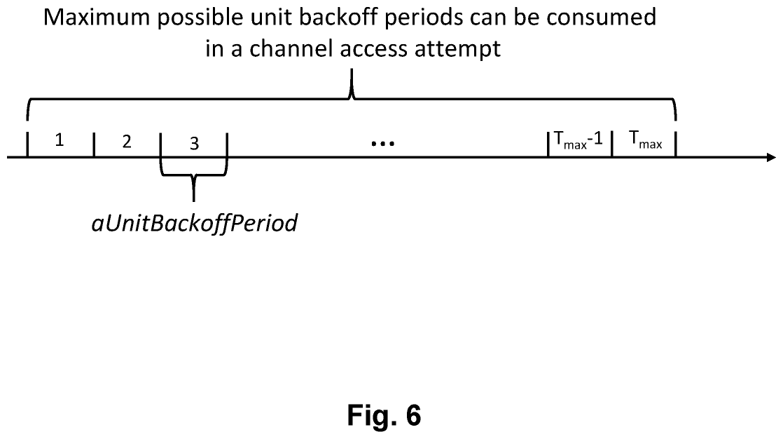

FIG. 5 shows IEEE 802.15.4 Non-Slotted CSMA algorithm, which starts with backoff exponent (BE) set to macMinBe and number of backoff (NB) set to 0 and performs the first backoff by delaying for random (2^{BE}−1) unit backoff periods. After completion of the backoff, the algorithm then performs clear channel assessment (CCA). If the channel is idle, channel access attempt successes. If the channel is busy, algorithm increments NB by 1 and sets BE=min{BE+1, macMaxBe}. If the NB exceeds macMaxCsmaBackoffs, channel access attempt fails. Otherwise, algorithm goes for another random backoff.

Denote as NBₘₐₓ the macMaxCsmaBackoffs. Then IEEE 802.15.4 Non-Slotted CSMA backoff window Wi on the i-th backoff is given by Wᵢ=min{2^{macMinBe+i}, 2^{macMaxBe}}, i=0, 1, 2, . . . , NBₘₐₓ. On the i-th backoff, an IEEE 802.15.4 node has a uniform probability 1/Wᵢ to draw 0, 1, . . . , Wᵢ−1 backoff periods. Therefore, Σᵢ₌₀^{NP}^{ₘₐₓ}(Wᵢ−1) is the maximum number of backoff periods that can be backoffed in a channel access attempt. Consider that in IEEE 802.15.4 Non-Slotted CSMA mode, only one CCA is performed after completion of each backoff, Tₘₐₓ=Σᵢ₌₀^{NP}^{ₘₐₓ}Wᵢ is the maximum number of backoff periods that can be consumed in a channel access attempt. Accordingly, for a channel access attempt, the time is divided into backoff periods starting from backoff period 1 to backoff period Tₘₐₓ as shown in FIG. 5, where the length of a backoff period is equal to aUnitBackoffPeriod defined in IEEE 802.15.4 standard. On the i-th backoff, the expected number of backoff periods is given by (Wᵢ−1)/2. Plus one period for CCA operation, denote as kᵢ the expected number of backoff periods elapsed up to the i-th backoff, then

$${k}_{0} = 0 , {k}_{i} = {\sum }_{t = 0}^{i - 1} ( {w}_{t} + 1 ) / 2 , i = 1 , 2 , … , {NP}_{max} \qquad ( 1 )$$

To model IEEE 802.15.4 Non-Slotted CSMA as a Markov chain, the backoff counter decrement states are omitted since the state transition probability in backoff counter decrement process is always 1. Define following Markov chain states:

D(i, j, kᵢ): Node performs the i-th backoff by delaying j backoff periods starting at kᵢ-th backoff period, which indicates that the previous i backoffs from 0-th backoff to (i−1)-th backoff failed, 0≤i≤NBₘₐₓ, 0≤j≤Wᵢ−1 and i≤kᵢ≤Tₘₐₓ.

C(i, j): Node performs CCA operation at the (kᵢ+j+1)-th backoff period on the i-th backoff, which indicates that node delayed j backoff periods on i-th backoff, 0≤i≤NBₘₐₓ and 0≤j≤Wᵢ−1.

B(−1): Node prepares to gain channel for a data packet transmission. To transmit a data packet, IEEE 802.15.4 CSMA algorithm performs first backoff, i.e., 0-th backoff, no matter channel is idle or not. Therefore, the channel is considered as busy on the (−1)-th backoff.
B(i): Channel is busy on the i-th backoff, 0≤i≤NBₘₐₓ.
T: Node gains the channel and starts data packet transmission.
F: Node fails gaining the channel as the number of backoffs reaches the NBₘₐₓ.

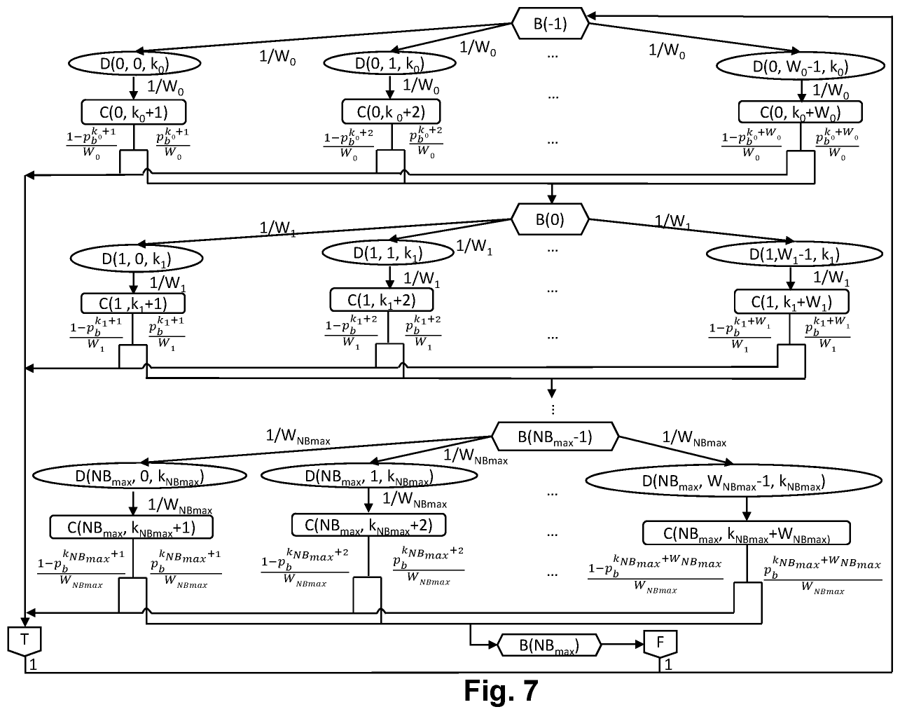

Denote as pr the channel busy probability in the backoff period k, k=1, 2, . . . , Tₘₐₓ. FIG. 7 shows the invented Markov chain mode for IEEE 802.15.4 Non-Slotted CSMA algorithm, where hexagon shows state B (i), circle represents state D(i,j,k), rectangle serves as state C(i,j), pentagon with caption T acts as state T and pentagon with caption F illustrates state F. Define following state transition probabilities:

$${d}_{i , j} = p ( D ( i , j , {k}_{i} ) \vert B ( i - 1 ) ) , 0 \leq i \leq {NB}_{max} , 0 \leq j \leq {W}_{i} - 1 \qquad ( 1 )$$

$${c}_{i , j} = p ( C ( i , {k}_{i} + j + 1 ) \vert D ( i , j , {k}_{i} ) , 0 \leq i \leq {NB}_{max} , 0 \leq j \leq {W}_{i} - 1 \qquad ( 2 )$$

$${b}_{i , j} = p ( B ( i ) \vert C ( i , {k}_{i} + j ) , 0 \leq i \leq {NB}_{max} , 1 \leq j \leq {W}_{i} ( 2 ) \qquad ( 3 )$$

$${t}_{i , j} = p ( T \vert C ( i , {k}_{i} + j ) ) , 0 \leq i \leq {NB}_{max} , 1 \leq j \leq {W}_{i} \qquad ( 4 )$$

$${f}_{j} = p ( F \vert C ( {NB}_{max} , {k}_{{NB}_{max}} + j ) ) , 1 \leq j \leq {W}_{NBmax} \qquad ( 5 )$$

Define b₋₁=1 and denote as bᵢ the probability p(Bᵢ), 0≤i≤NBₘₐₓ. Using Markov chain model shown in FIG. 7, following equations can be obtained:

$${d}_{i , j} = \frac{{b}_{i - 1}}{{W}_{i}} , 0 \leq i \leq {NB}_{max} , 0 \leq j \leq {W}_{i} - 1 \qquad ( 3 )$$

$${c}_{i , j} = {d}_{i , j} , 0 \leq i \leq {NB}_{max} , 1 \leq j \leq {W}_{i} - 1$$

$${b}_{i , j} = {d}_{i , j} {p}_{b}^{{k}_{i} + j} , 0 \leq i \leq {NB}_{max} , 1 \leq j \leq {W}_{i}$$

$${b}_{i} = {\sum }_{j = 1}^{{W}_{i}} {b}_{i , j} , 0 \leq i \leq {NB}_{max}$$

$${t}_{i , j} = {d}_{i , {k}_{i} + j} ( 1 - {p}_{b}^{{k}_{i} + j} ) , 0 \leq i \leq {NB}_{max} , 1 \leq j \leq {W}_{i}$$

$${f}_{j} = {d}_{{NB}_{max} , {k}_{{NB}_{max}} + j} {p}_{b}^{{k}_{{NB}_{max}} + j} , 1 \leq j \leq {W}_{NBmax}$$

$$p ( T ) = {\sum }_{i = 0}^{{NB}_{max}} {\sum }_{j = 1}^{{W}_{i}} {t}_{i , j} , p ( F ) = {\sum }_{j = 1}^{{W}_{{NB}_{max}}} {f}_{j}$$

$$p ( {C}_{0} \vert T ) = 1 , p ( {C}_{0} \vert F ) = 1$$

To transmit a data packet, an 802.15.4 node conducts the 0-th backoff with probability 1. It conducts the i-th backoff only if the previous i backoffs from the 0-th backoff to the (i−1)-th backoff failed. Therefore, the probability of an 802.15.4 node conducts the i-th backoff is Πₙ₌₀ⁱ⁻¹bₙ, i=1, 2, . . . , NBₘₐₓ. Consider that the expected number of backoff periods consumed on the i-th backoff is (Wᵢ+1)/2, the expected number of backoff periods to gain channel for a TCP packet transmission is given by

$${N}_{bp} = \frac{{W}_{o} + 1}{2} + {\sum }_{i = 1}^{{NB}_{max}} {\prod }_{n = 0}^{i - 1} {b}_{n} \frac{{W}_{i} + 1}{2} . \qquad ( 4 )$$

### RTT Computation Over Heterogeneous Path

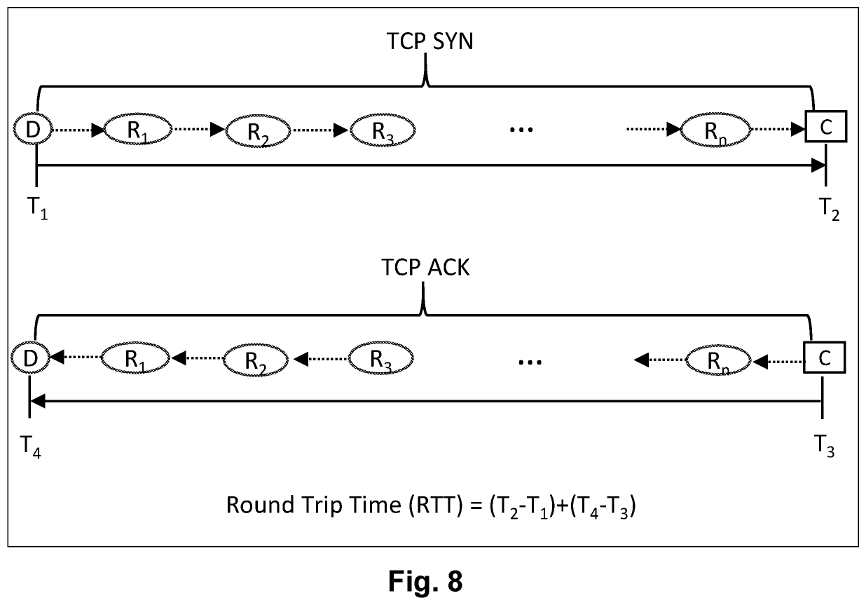

MPTCP scheduling depends on the RTT, which is defined by IETF RFC 793 as the elapsed time between sending a data octet and receiving an acknowledgment. However, no prior art found addresses RTT computation. The present invention uses TCP SYN and TCP ACK messages to compute RTT as shown in FIG. 8. Both SYN and ACK messages do not have payload and therefore, have same size. Consider a heterogeneous path from data node D to data center C with n relay nodes: R₀=D→R₁→R→R₃→ . . . →Rₙ→C, where nodes Rₙ₋₁ and Rₙ can be multi-link nodes. TCP SYN packet is sent from node D to data center C. Upon receiving TCP SYN packet, node C sends TCP ACK to node D. Conceptually, if TCP SYN packet is sent at time T₁ by node D and received by node C at time T₂ and TCP ACK packet is sent by node C at time T₃ and received by node D at time T₄, then the RTT on this path is given by

$$RTT = ( {T}_{2} - {T}_{1} ) + ( {T}_{4} - {T}_{3} ) . \qquad ( 5 )$$

To compute T₂−T₁ and T₄−T₃, the time a packet spent at each hop needs to be computed. At an IEEE 802.15.4 node, the time a packet consumed includes:
Random queuing time
Random channel access delay
Fixed RX to TX turnaround time
Fixed packet transmission time
Fixed MAC ACK transmission time
However, the time a packet spent at a ML node only includes
Random queuing time
Fixed packet transmission time

The packet transmission time is fixed once packet size and bandwidth are given. In addition, IEEE 802.15.4 nodes are typically half-duplex devices, thus turnaround is needed. However, the turnaround time is fixed and defined as aTurnaroundTime in IEEE 802.15.4 standard. Furthermore, IEEE 802.15.4 MAC sends a MAC layer ACK before forwarding TCP packet to upper layers, but MAC ACK transmission time is also fixed. Therefore, the task is to compute random queuing time and random channel access delay of IEEE 802.15.4 node. It is impractical to compute the exact value of a random variable. Accordingly, the expected values are computed.

The M/M/1/K queue is applied to model the expected queuing time. Assume each node has one queue of size K with a single server and packet arrives according to a Poisson process with rate λ (packets/s). Service process follows an exponential distribution with rate μ (packets/s). Let B₁₅ and B_{5g} be IEEE 802.15.4 bandwidth and 5G bandwidth, respectively, then μ=B₁₅/8*PacketSize for IEEE 802.15.4 node and μ=B_{5g}/8*PacketSize for multi-link node. Denote as ρ=λ/μ. From M/M/1/K theory, the probability that queue contains n (n=0, 1, 2, . . . , K) packets is given by

$${p}_{n} = \{ \begin{matrix}\frac{1}{K + 1} , & ρ = 1 \\ \frac{( 1 - ρ ) {ρ}^{n}}{1 - {ρ}^{K + 1}} , & ρ \neq 1\end{matrix} \qquad ( 6 )$$

Therefore, the probability that a packet is lost due to queue overflow (i.e., n=K) is

$${p}_{K} = \{ \begin{matrix}\frac{1}{K + 1} , & ρ = 1 \\ \frac{( 1 - ρ ) {ρ}^{K}}{1 - {ρ}^{K + 1}} , & ρ \neq 1\end{matrix} \qquad ( 7 )$$

Let N_{q} be the expected number of packets in the queue, the N_{q} can be calculated as

$${N}_{q} = \{ \begin{matrix}\frac{K}{2} , & ρ = 1 \\ \frac{ρ}{1 - ρ} - \frac{K + 1}{1 - {ρ}^{K + 1}} , & ρ \neq 1\end{matrix} \qquad ( 8 )$$

Assume queue is not full (otherwise packet is discarded), then considering current packet being added into the queue, the expected queuing time T_{q} is given by

$${T}_{q} = \frac{{N}_{q} + 1}{μ} . \qquad ( 9 )$$

Using T_{q} in Eq. (9) and N_{bp} in Eq. (4), the expected time a packet consumed at an IEEE 802.15.4 node Rₙ is given by

$${T}_{e} ( n ) = {T}_{q} + {N}_{bp} * \vert BP \vert + {T}_{turnaround} + \frac{\vert SYN \vert}{{B}_{15}} + {T}_{MAC - ACK} \qquad ( 10 )$$

where |BP| is the length of the backoff period, i.e., aUnitBackoffPeriod, and |SYN| is the size of TCP SYN packet measured at PHY layer, which is also the TCP packet header size (HS).

On the other hand, the expected time a packet spent at a multi-link node Rₙ is

$${T}_{e} ( n ) = {T}_{q} + \frac{\vert SYN \vert}{{B}_{5 g}} . \qquad ( 11 )$$

Therefore, TCP SYN packet travel time over n+1 hop path from node D to data center C is given by

$${T}_{2} - {T}_{1} = {\sum }_{n = 0}^{N} {T}_{e} ( n ) . \qquad ( 12 )$$

Since TCP SYN and ACK have same size, TCP ACK packet travel time from data center C to node D is assumed same as TCP SYN packet travel time, i.e., T₄−T₃=T₂−T₁. Therefore, the RTT over the given path is given by

$$R T T = ( {T}_{2} - {T}_{1} ) + ( {T}_{4} - {T}_{3} ) = 2 * {\sum }_{i = 0}^{N} {T}_{e} ( i ) . \qquad ( 13 )$$

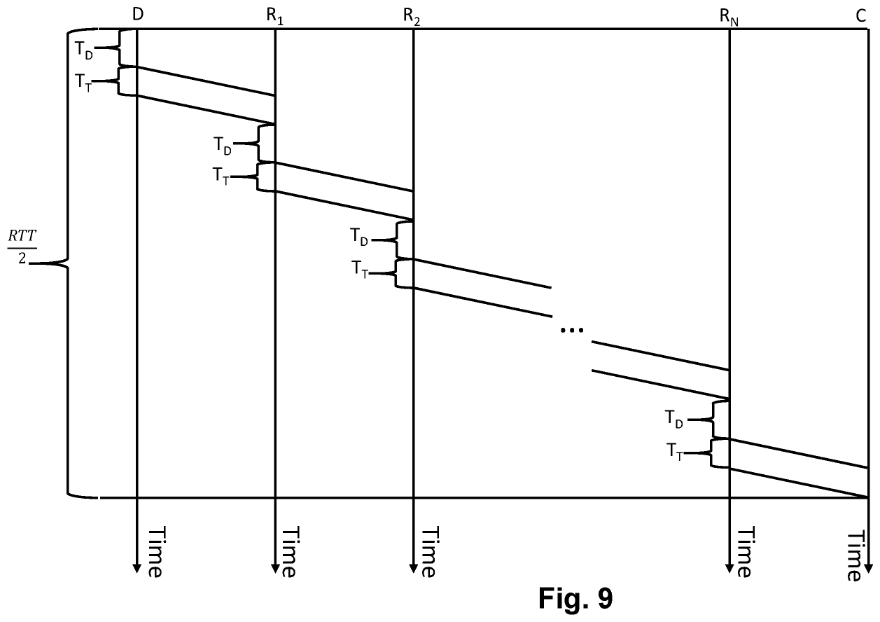

FIG. 9 shows the hop by hop RTT computation, where at each hop, there are classes of time consumption, i.e., delay time T_{D} and packet transmission time T_{T}. where T_{D} includes queuing time, channel access contention time and TX to TX turnaround time for IEEE 802.15.4 node and queuing time for multi-link node and T_{T} includes packet transmission time and MAC ACK transmission time for IEEE 802.15.4 node and packet transmission time for multi-link node

### MPTCP Path Scheduling Over Multi-Hop Heterogeneous IoT Networks

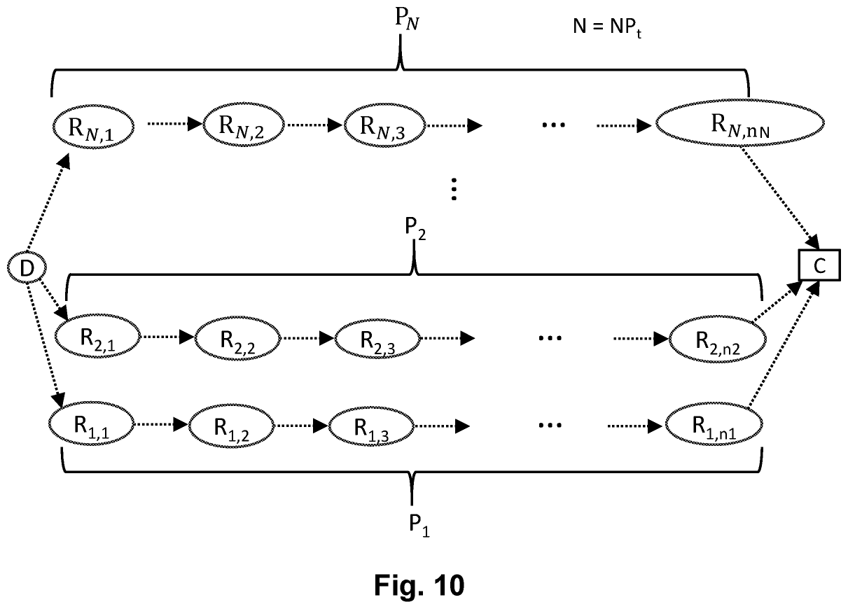

MPTCP scheduling is to compute the cwnd to ensure packets arrive at data center C over multiple paths in order. In IoT networks, a data node D not only delivers its data packets but may also relay packets. Data packets are scheduled based on first come first serve principle. Assume node D has NPₜ paths P₁, P₂, . . . , P_{NPt} arranged in RTT ascending order as shown in FIG. 10, where NPₜ paths have different lengths n₁+1 hops, n₂+1 hops and n_{NPt}+1 hops, respectively. Consider a path Pᵢ (i=1, 2, . . . , NPₜ) and denote as wᵢ the cwnd of the path Pᵢ. Assume TCP ACK is delayed for wᵢ packets and a new round starts after current round completes. Denote as Bᵢ either B₁₅ if node D is an IEEE 802.15.4 node or B_{5g} if node D is a multi-link node on the path Pᵢ. Assume node D has enough packets for all paths. For path P_{NPt}, w_{NPt} packets can be scheduled. For path Pᵢ (i=1, 2, . . . , NPₜ−1), denote as Tᵢ(1)=RTTᵢ₊₁/2, the task is to compute the number of packets that can be scheduled in time period Tᵢ(1). Multiple rounds can complete in Tᵢ(1) time. Denote as Tᵢ(r) and wᵢ(r) the remaining time and the wᵢ at the start of r-th round, respectively. To transmit m TCP data packets with payload of size PS over path Pᵢ, replace |SYN| with HS+PS in Eq. (12) to get the expected time to deliver first data packet as

$${T}_{i}^{1} = \frac{R T {T}_{i}}{2} + \frac{{\sum }_{n = 0}^{N} P S}{{B}_{i}} .$$

The remaining m−1 data packets can be transmitted sequentially, i.e., once current packet is transmitted, node D starts channel access contention for next packet transmission. Therefore,

$${T}_{i}^{m} = {T}_{i}^{1} + ( m - 1 ) ( {T}_{e} ( D ) + \frac{H S + P S}{{B}_{i}} )$$

is the expected time to deliver m data packets over path Pᵢ. There are following four cases for the r-th scheduling round:
(1) Tᵢ(r)<Tᵢ¹: Has no time to transmit a new packet, scheduling ends.

$${T}_{i}^{1} \leq {T}_{i} ( r ) < {T}_{i}^{{w}_{i} ( r )} + \frac{R T {T}_{i}}{2} + {T}_{i}^{1} : \qquad ( 2 )$$

Has time to transmit wᵢ(r) packets, but no time for recovery or starting (r+1)-th round.

$${T}_{i}^{{w}_{i} ( r )} + \frac{R T {T}_{i}}{2} + {T}_{i}^{1} \leq {T}_{i} ( r ) < {RTO}_{i} + \frac{R T {T}_{i}}{2} : \qquad ( 3 )$$

Has time to complete r-th round and start (r+1)-th round if lost packets can be recovered by FR, but has no enough time to complete RTO retransmission. Therefore, the (r+1)-th round will not start if lost packets cannot be recovered by FR. There could be three cases described next.

$${T}_{i} ( r ) \geq {RTO}_{i} + \frac{R T {T}_{i}}{2} : \qquad ( 4 )$$

Time is enough to finish r-th round, retransmit lost packets via FR or FR and start (r+1)-th round. There could also be three cases described next.

### Case 3 Sub-Cases

Case 3-1: No packet loss. In this case, wᵢ(r) packets can be scheduled, the (r+1)-th will start in SS or CA state with probability p(0|wᵢ(r))=

$$( \begin{matrix}0 \\ {w}_{i} ( r )\end{matrix} ) {{l}^{0} ( 1 - l )}^{{w}_{i} ( r )} ,$$

$${T}_{i} ( r + 1 ) = {T}_{i} ( r ) - {T}_{i}^{{w}_{i} ( r )} ,$$

$${sst}_{i} ( r + 1 ) = s s {t}_{i} ( r )$$

$$and$$

$${w}_{i} ( r + 1 ) = \{ \begin{matrix}2 * {w}_{i} ( r ) , {w}_{i} ( r ) < {sst}_{i} ( r ) \\ {w}_{i} ( r + 1 ) , {w}_{i} ( r ) \geq {sst}_{i} ( r )\end{matrix}$$

Case 3-2: With packet loss, but the number of lost packets m≤wᵢ(r)−3 with probability

$${\sum }_{m = 1}^{{w}_{i} ( r ) - 3} ( \begin{matrix}m \\ {w}_{i} ( r )\end{matrix} ) {{l}^{m} ( 1 - l )}^{{w}_{i} ( r ) - m}$$

that lost packets can be recovered by FR. In this case, wᵢ(r) packets can be scheduled, the (r+1)-th round starts with probability 1,

$${T}_{i} ( r + 1 ) = {T}_{i} ( r ) - ( {T}_{i}^{{w}_{i} ( r )} + {\sum }_{m = 1}^{{w}_{i} ( r ) - 3} ( \begin{matrix}m \\ {w}_{i} ( r )\end{matrix} ) {{l}^{m} ( 1 - l )}^{{w}_{i} ( r ) - m} {T}_{i}^{m} ) , \\ {w}_{i} ( r + 1 ) = s s {t}_{i} ( r + 1 ) = ⌊ \frac{{w}_{i} ( r )}{2} ⌋ .$$

Case 3-3: With packet loss, but number of lost packets is large enough with probability Σ_{m=w}_{ᵢ}₍ᵣ₎₋₂^{w}^{ᵢ}^{(r)}(_{w}_{ᵢ}₍ᵣ₎^{m})l^{m}(1−l)^{w}^{ᵢ}^{(r)-m} so that lost packets cannot be recovered by FR. In this case, wᵢ(r) packets can be scheduled, but there is no enough time for RTO recovery, thus the (r+1)-th round will not start, i.e., Tᵢ(r+1)=0 and wᵢ(r+1)=0.
Case 4 sub-cases
Case 4-1: Same as Case 3-1.
Case 4-2: Same as Case 3-2.

Case 4-3: With packet loss and number of lost packets (m>wᵢ(r)−3) with probability

$${\sum }_{m = {w}_{i} ( r ) - 2}^{{w}_{i} ( r )} ( \begin{matrix}m \\ {w}_{i} ( r )\end{matrix} ) {{l}^{m} ( 1 - l )}^{{w}_{i} ( r ) - m}$$

can be recovered by RTO. In this case, wᵢ(r) packets can be scheduled, the (r+1)-th round will start with probability 1.

$${T}_{i} ( r + 1 ) = {T}_{i} ( r ) - ( {T}_{i}^{{w}_{i} ( r )} + {RTO}_{i} ) ,$$

$${sst}_{i} ( r + 1 ) = ⌊ \frac{{w}_{i} ( r )}{2} ⌋$$

$$and$$

$${w}_{i} ( r + 1 ) = {w}_{m i n} .$$

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

1. A node device for a heterogeneous wireless communications network including single-link data nodes, multi-link data nodes, data centers, and a 5G base station network, wherein the node device comprising:
a transceiver configured to transmit and receive management packets and data packets in the heterogeneous wireless network;
a memory configured to store computer executable programs for performing an MPTCP path establishment algorithm, an MPTCP Adaptive NewReno (A-NewReno) congestion control algorithm, and an MPTCP path scheduling algorithm for the data packets;
a processor configured to perform steps of the computer executable programs, wherein the steps comprise:
forming an MPTCP path in the heterogeneous wireless communications network by transmitting and receiving an extended destination oriented directed acyclic graph (DODAG) information object (DIO) message to form a upward path from a data node to a data center, transmitting and receiving an extended destination advertisement object (DAO) message in responding to receiving a DIO message to form a downward path from a data center to a data node, and assigning a path identification data (ID) for a upward path established;
computing a congestion window (cwnd) by determining a minimum congestion window (cwndₘᵢₙ) and a maximum congestion window (cwndₘₐₓ); and
scheduling transmission of the data packets along multiple paths formed from the data node to the data center to ensure the data packets arrive at the data center in the order of the transmission time over multiple paths.

2. The node device of claim 1, wherein the extended DIO message additionally contains the path traversed by the DIO message and the node type of DIO message transmitter with 0 indicating single-link node and 1 indicating multi-link node, wherein the extended DAO message additionally contains the path formed and the path ID assigned.

3. The node device of claim 2, wherein a upward path is formed by reversing the path contained in DIO message and attaching the DIO message receiver as the path starting node, wherein the formed upward path is assigned a path identifier (ID), wherein a downward path configured by the data center using information contained in DAO messages.

4. The node device of claim 1, wherein a number of paths threshold (NPₜ) is defined to limit the number of MPTCP paths formed by a data node in a heterogeneous wireless communications network.

5. The node device of claim 4, wherein a multi-link data node builds a one-hop MPTCP path to the data center if the node can directly communicate with the data center or builds a two-hop MPTCP path via base station network to the data center if the node cannot directly communicate with the data center, wherein a single-link node can build up to NPₜ MPTCP paths to the data center, wherein an MPTCP path of a single-link node can be one-hop or multiple hops.

6. The node device of claim 1, wherein the Adaptive NewReno congestion control algorithm determines a congestion window (cwnd) for an MPTCP path in a scheduling round.

7. The node device of claim 6, wherein the Adaptive NewReno congestion control algorithm extends the conventional NewReno algorithm in three aspects: (1) the minimum congestion window (cwndₘᵢₙ) and the maximum congestion window (cwndₘₐₓ) adaptation, (2) the retransmit timeout (RTO) timer adaptation and (3) the congestion window update frequency adaptation.

8. The node device of claim 7, wherein the congestion window (cwnd) is a parameter to limits the number of data packets to be scheduled alone an MPTCP path in a scheduling round such that the number of data packets scheduled in a scheduling round cannot exceed the cwnd.

9. The node device of claim 7, wherein a data node closer to the data center has the smaller minimum congestion window (cwndₘᵢₙ) and the larger maximum congestion window (cwndₘₐₓ), wherein a data node away from the data center has the larger minimum congestion window (cwndₘᵢₙ) and the smaller maximum congestion window (cwndₘₐₓ), wherein the RTO timer is proportional to the MPTCP path length such that a shorter MPTCP path has a shorter RTO timer and a longer MPTCP path has a longer RTO timer, wherein a data node close to the data center updates the congestion window more frequently, wherein a data node away from the data center updates the congestion control window less frequently.

10. The node device of claim 1, wherein the data packet scheduling algorithm applies a round trip time (RTT) and a congestion window (cwnd) to determine the number of packets to be transmitted alone an MPTCP path in a scheduling round.

11. The node device of claim 9, wherein the round trip time (RTT) for an MPTCP path is an elapsed time between sending a data octet by a data node to the data center alone the MPTCP path and receiving an acknowledgment (ACK) from the data center by the data node alone the same MPTCP path.

12. The node device of claim 10, wherein the elapsed time is sum of the time spent by the data octet traverses from the data node to the data center alone the MPTCP path and the time spent by the ACK traverses from the data center to the data node alone same MPTCP path.

13. The node device of claim 12, wherein the time spent by the data octet is sum of the time spent by the data octet at all nodes alone the MPTCP path, wherein the time spent by the ACK is sum of the time spent by the ACK at all nodes alone the same MPTCP path.

14. The node device of claim 13, wherein the time spent by the data octet or the ACK at a single-link node (IEEE 802.15.4 node) includes (1) a random queuing time, (2) a random channel access delay time, (3) a fixed reception to transmission turnaround time, (4) a fixed packet transmission time and (5) a fixed MAC layer ACK transmission time, wherein the time spent by the data octet or the ACK at a multi-link node (5G node) includes (1) a random queuing time and (2) a fixed packet transmission time.

15. The node device of claim 14, wherein the random queuing time spent by the data octet or the ACK is computed as N_{q}+1/μ, where N_{q} is the number of packets in the queue given by equation (8) and μ is the packet transmission rate.

16. The node device of claim 14, wherein the random channel access delay time consumed by a single-link node (IEEE 802.15.4 node) is computed as N_{bp}*|BP|, where |BP| is the length of the IEEE 802.15.4 backoff period and N_{bp} is the expected number of backoff periods given by equation (4).

17. The node device of claim 1, wherein the scheduling algorithm schedules packet transmission over multiple MPTCP paths based on the fastest RTT, wherein a MPTCP path with the smaller RTT is scheduled to transmit more data packets in a scheduling, wherein a MPTCP path with the larger RTT is scheduled to transmit fewer data packets in a scheduling round.

18. The node device of claim 17, wherein a scheduling round for an MPTCP path is the time spent to successfully transmit all data packets scheduled, wherein the success of data packet transmission is confirmed by the acknowledgement from the data center.

19. The node device of claim 17, wherein the scheduling algorithm arranges MPTCP paths P₁, P₂, . . . , P_{NPt} in RTT ascending order as RTT₁≤RTT₂≤ . . . ≤RTT_{NPt}, wherein the corresponding congestion windows is determined as cwnd₁, cwnd₂, . . . , cwnd_{NPt}, respectively, wherein the cwnd_{NPt} packets are scheduled for MPTCP path P_{NPt} in a scheduling round, wherein multiple scheduling round can take place for MPTCP paths P₁, P₂, . . . , P_{NPt-1} within an MPTCP path P_{NPt} scheduling round depending their RTTs and congestion windows.

20. The node device of claim 19, wherein the number of data packets scheduled for an MPTCP path Pᵢ (i=1, 2, . . . , NPₜ−1) within an MPTCP path P_{NPt} scheduling round is sum of the data packets scheduled in all multiple rounds.
